(19) United States
(12) Patent Application Publication
(10) Pub. No.: US 2009/0277733 A1
(43) Pub. Date: Nov. 12, 2009

(54) Kolben-Zylinderaggregat

(75) Inventor: Frank DOFFING, Kastellaun (DE)

Correspondence Address: COHEN, PONTANI, LIEBERMAN & PAVANE LLP, 551 FIFTH AVENUE, SUITE 1210, NEW YORK, NY, 10176, US

(73) Assignee: Stabilus GmbH, Koblenz (DE)

(21) Appl. No.: 12/123,076

(22) Filed: May 19, 2008

(30) Foreign Application Priority Data
May 19, 2007 (DE) 10 2007 023 449.1
May 19, 2008 (DE) 10 2008 024 166.0

(51) Int. Cl. F16F 9/53

(52) U.S. Cl. 188/267.2

(57) ABSTRACT

Presented is a piston-cylinder unit that includes a closed first end, a cylinder, a sealing device, and a piston installed in the cylinder with freedom to slide back and forth. The piston divides the cylinder into a first space at the closed end and a second space at the end opposite the closed end. The piston-cylinder unit further includes a piston rod attached to one side of the piston. The piston rod projects through the second space and is guided out of the cylinder concentrically with the longitudinal center axis of the cylinder at the second end, opposite the first end, in a sealed manner through the sealing device. The piston-cylinder unit further includes a ferrofluid, and at least one magnetic element that has a magnetic field, which cooperates with the ferrofluid present in the cylinder.

The invention pertains to a piston-cylinder unit with a closed first end; a cylinder; a piston, which is installed with freedom to slide back and forth in the cylinder, and which divides the cylinder into a first space near the closed end and a second space at the end opposite the closed end; and a piston rod, which is attached to one side of the piston, which projects through the second space, and which is guided out of the cylinder concentrically to the longitudinal center axis of the cylinder at a second end opposite the first end in a sealed manner through a sealing device.

A piston-cylinder unit, which can be used as a gas spring, for example, comprises a cylinder, in which a gas is provided, which can be compressed by a piston installed in the cylinder. So that the piston can be actuated, a piston rod is connected to it. A sealing device, which seals off the cylinder, is connected to the cylinder. Because the piston rod is guided through the sealing device so that the piston can be actuated from the outside, it is necessary for the sealing device to seal off both the connection between the cylinder and the sealing device and the connection between the sealing device and the piston rod. To prevent the fluid, for example, a gas, inside the cylinder from escaping, the sealing device normally has seals, which rest against the piston rod with the greatest possible force, this being necessary to guarantee the seal. This, however, leads to considerable friction between the sealing device and the piston rod, which leads to a large amount of wear. The elastic force which can be achieved by the compression of the gas is also decreased by the prevailing frictional forces.

It is known from U.S. Pat. No. 6,202,806 B1 that the sealing device connected to the cylinder can be omitted, and that the necessary sealing effect can be achieved solely in the area of the piston. For this purpose, a ferrofluid is provided between the piston and the cylinder, and electromagnets are provided in the piston to hold the ferrofluid in place between the cylinder and the electromagnets of the piston, which has the effect of sealing off the cylinder. The magnetic force of the electromagnets holds the ferrofluid in place between the cylinder and the piston, as a result of which a good sealing action can be obtained and friction is reduced at the same time.

The disadvantage of a gas spring of this type is that the piston and the piston rod must have a relatively complicated structure to accommodate the electromagnets and to supply them with current. There is also the danger that, during the operation of the gas spring, a slight tilt of the piston rod can cause the piston to cant, which limits the functionality of the gas spring and increases the wear. In addition, the canting of the piston can cause grooves to form in the cylinder, in which some of the ferrofluid can collect. This has the result that, over the service life of the gas spring, more and more ferrofluid is removed from the gap between the piston and the cylinder, as a result of which the sealing action is lost.

The object of the present invention is to create a piston-cylinder unit characterized by reduced wear and improved sealing action.

The object is achieved according to the invention in that the piston-cylinder unit comprises at least one magnetic element, the magnetic field of which cooperates with a ferrofluid present in the cylinder.

The inventive piston-cylinder unit comprises a cylinder, which is filled with gas, especially a compressed gas, or oil. The cylinder holds a piston, which is connected to a piston rod, which makes it possible to actuate the piston. A sealing device is connected to the cylinder to seal off the cylinder. According to the invention, the sealing device has at least one magnetic element, and a ferrofluid is also provided in, for example, a gap or intermediate space between the sealing device and the piston rod and/or between the sealing device and the cylinder.

Because the piston rod is guided both by the piston and by the sealing device, the piston cannot become canted. Because the ferrofluid is a liquid or suspension, friction between the sealing device and the piston rod is considerably reduced. This decreases the wear. The ferrofluid, furthermore, is able to compensate for surface irregularities caused by machining tolerances, for example, or by roughness. Because the ferrofluid is not carried along but remains essentially stationary under the action of the magnet or magnets, it is possible to provide a relatively simple structure. For example, a channel can be provided to supply additional ferrofluid as necessary without the danger that the fresh fluid could fail to arrive in the area of the magnetic elements. It is not necessary, furthermore, to impose special requirements on the piston rod to ensure that it can position the ferrofluid in the correct area and keep it there.

Alternatively or as an elaboration, the piston can comprise the magnetic element, where a ferrofluid is provided between the piston and the cylinder.

According to the invention, at least one magnetic element can also be provided externally on the cylinder.

In a preferred embodiment, the magnetic elements are arranged in such a way that the magnetic poles of the magnetic elements are aligned in the radial direction with respect to each other, which means that the magnets themselves are also arranged radially. The magnetic north poles and the magnetic south poles are thus located on circles, as it were, oriented radially with respect to the cylinder. This makes it possible to provide an especially high magnetic field strength in the area of the ferrofluid.

It is especially preferred to arrange several magnetic elements next to each other in the axial direction and/or in the circumferential direction. This makes it possible to provide an especially strong magnetic field in the area of the ferrofluid. The several magnetic elements are preferably arranged in homopolar fashion. That means in particular that all of the magnetic elements have their magnetic south poles pointing radially inward and their magnetic north poles pointing radially outward or vice versa. As a result, an especially high magnetic field strength is generated at least for a certain partial area of the ferrofluid.

Depending on the application, it can be advantageous, preferably in the area of the magnetic element, to provide a sealing element to limit the flow of the ferrofluid in the axial direction. The sealing element at least makes it more difficult for the ferrofluid to escape. The sealing element is, for example, an elastomeric O-ring. It is not necessary for the sealing element to contribute to the sealing-off of the cylinder, because the ferrofluid itself is sufficient for this purpose. It is especially preferable for the sealing element to be arranged in the axially central area of the associated magnetic element. As a result, the sealing element will be present in an area where the magnetic field strength tends to be weaker than in other areas where the ferrofluid is present. For example, ferrofluid can be present between two adjacent, radially oriented magnetic elements, and two sealing elements in the central areas of their associated magnetic elements prevent the ferrofluid from escaping. The necessary sealing action is achieved by means of the ferrofluid alone.

The minimum of one magnetic element can comprise a permanent magnet, which can be produced in particular of SmCo or NdFeB in order to provide the strongest possible magnetic field.

Alternatively, the minimum of one magnetic element can comprise an electromagnet. Depending on the application, it can be advantageous for the electromagnet to be connected in particular to power lines which are a certain distance away from the piston rod. Relative movement between the piston rod and the power lines which would cause wear is thus avoided. The power lines can be guided through the cylinder, for example. The power lines in this case will preferably extend through the cylinder radially of the sealing device, so that the pass-through opening in the cylinder can be sealed off with the help of the ferrofluid which can be present between the sealing device and the cylinder. In addition or as an alternative, the power lines can pass along the sealing device and extend to the outside at one of the end surfaces of the cylinder. There is no need to provide the piston rod with any special design to allow the electromagnet to be supplied with power. The power lines, however, can also be passed through the piston rod.

The sealing device preferably has a soft magnetic jacket, which holds at least part of the magnetic element. With the help of the soft magnetic jacket, the magnetic flux density can be increased and/or locally intensified.

It is also possible for the piston to have at least one opening through which the gas can pass, as a result of which the gas spring is elaborated into a gas damper. The number and size of the openings will be adapted in particular to the desired damping properties.

The invention also pertains to a gas spring arrangement in which a gas spring, which can be expanded and elaborated as previously described, is provided. The cylinder is connected here to a first component by a first connection, whereas the piston rod is connected to a second component by a second connection. The first connection is geodetically higher than the second connection. Although the force of gravity acts on the ferrofluid, the magnetic force of the minimum of one magnetic element prevents the ferrofluid from flowing out of the cylinder along the piston rod under the effect of gravity. The inventive gas spring can thus be provided in particular in a gas spring arrangement which can turn and rotate. It is thus possible to replace lubricating oils, the positioning of which can be influenced only by the force of gravity and surface forces. In particular, the leakage of lubricating oil and the gradual running-dry over the service life of the gas spring are avoided, so that the service life of the inventive gas spring or gas spring arrangement is significantly increased. Leakage and running dry are reliably avoided by the action of the minimum of one magnet on the ferrofluid. Regardless of the position of the gas spring in relationship to the direction of the force of gravity or the direction of a centrifugal force, the sealing action will not weaken as a result of the loss of a fluid sealant.

Alternatively or as an elaboration, the magnetic element can be mounted on the cylinder with freedom of movement in the axial direction, as a result of which a freely adjustable intermediate hold position of the piston-cylinder unit can be provided.

As a further elaboration, a jacket tube is connected to the end of the piston rod facing away from the piston and extends at least partially over the cylinder, where the magnetic element is located at the open end of the jacket tube facing the first connecting device. As a result, the piston and the magnetic element are always opposite each other.

The invention is explained in greater detail below with reference to the attached drawings, which illustrate preferred exemplary embodiments:

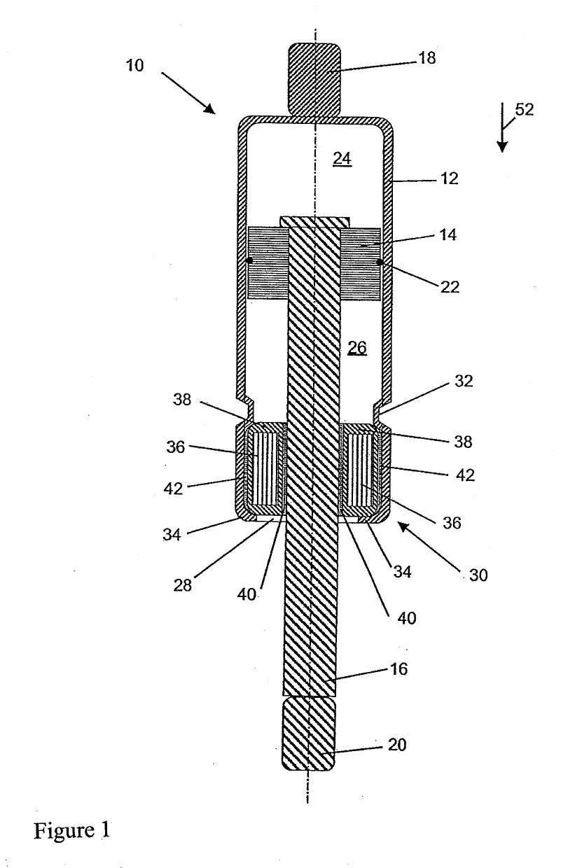

FIG. 1 shows a schematic cross-sectional view of a first embodiment of an inventive gas spring;

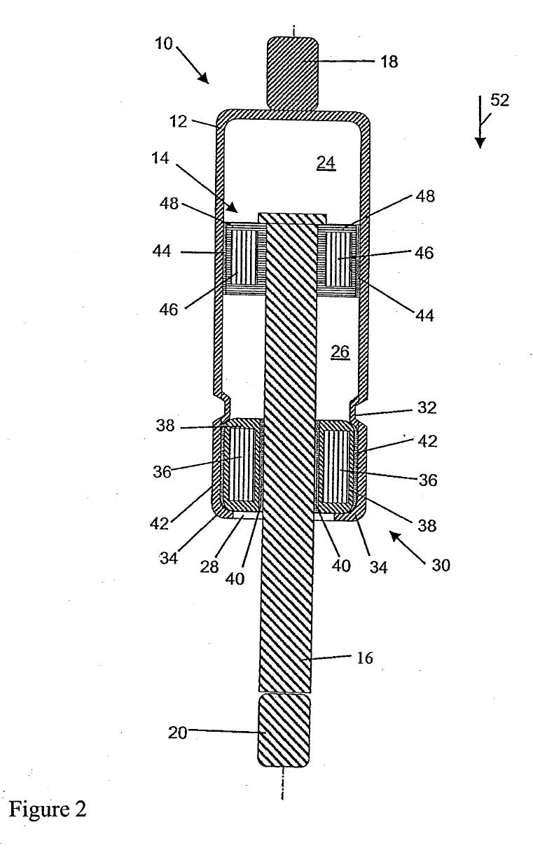

FIG. 2 shows a schematic cross-sectional view of a second embodiment of the inventive gas spring; and

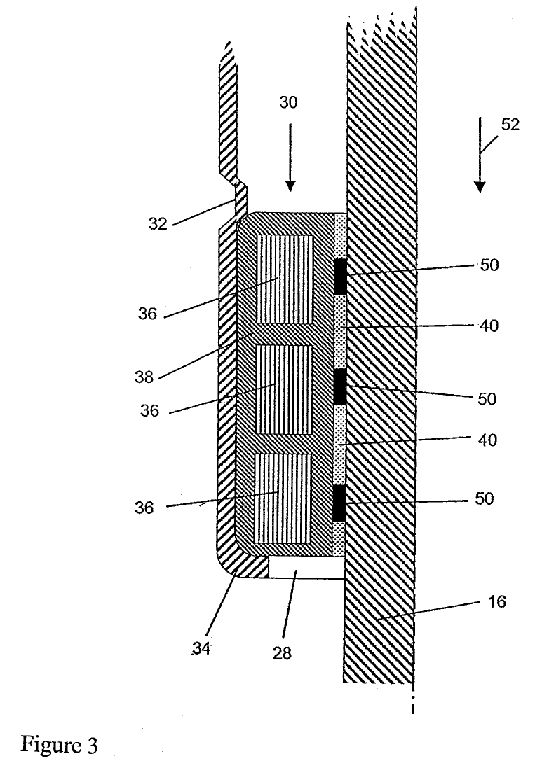

FIG. 3 shows a schematic cross-sectional view of a sealing device for the gas springs shown in FIGS. 1 and 2.

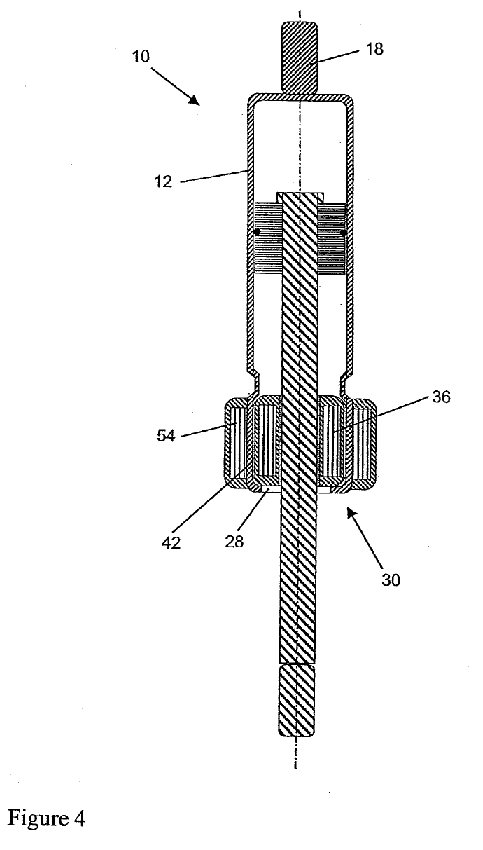

FIG. 4 shows a schematic cross-sectional view of a third embodiment of the inventive gas spring; and

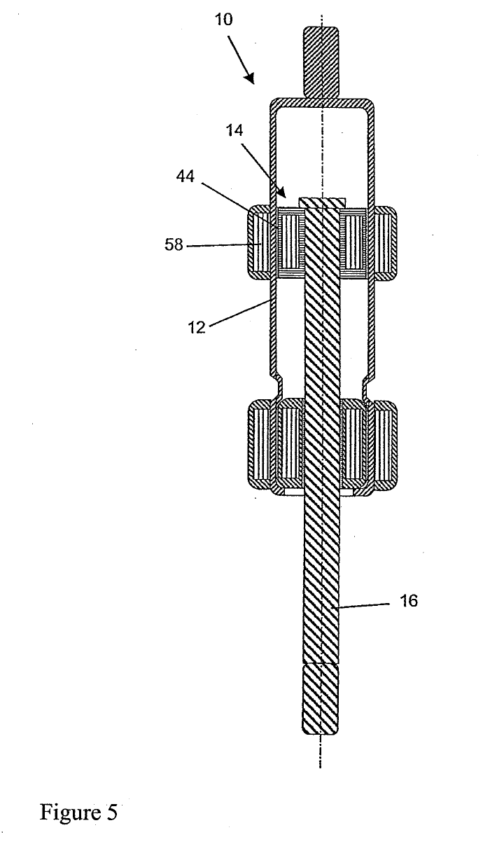

FIG. 5 shows a schematic cross-sectional view of a fourth embodiment of the inventive gas spring.

FIG. 1 shows, by way of example, the inventive piston-cylinder 10 in the form of a gas spring comprising a cylinder 12, which is closed at one end and in which a gas is enclosed between a piston 14 and the cylinder 12.

A piston rod 16 is connected to the piston 14 to actuate the piston 14. A first connecting device 18 is connected to the cylinder 12 so that the cylinder 12 can be connected to a first component (not shown). In corresponding fashion, a second connecting device 20 is connected to the piston rod 16 so that the piston rod 16 can be connected to a second component. In the exemplary embodiment shown here, the piston 14 has an elastic rubber seal in the form of an O-ring 22.

The piston 14 divides the pressure tube 12 into a first space 24 and a second space 26. The gas to be compressed can be present in the first space 24, whereas the second space 26 is essentially gas-free. When the piston rod 16 is pushed into the cylinder 12, the gas in the first space 24 is compressed, as a result of which the pressure there increases, whereas at the same time a negative pressure can develop in the second space 26. As a result of the forces thus generated, the gas spring 10 can make available an elastic force. It is also possible for the second space 26 to be filled with gas and for the first space 24 to be essentially gas-free. In this case, the elastic force provided by the gas spring 10 acts in the opposite direction.

In addition, both the first space 24 and the second space 26 are filled with a pressurized gas. The fluid can flow from one space to the other through, for example, an axial groove (not shown) in the cylinder or through one or more bores (not shown) in the piston 14, through which the gas can flow from the first space 24 into the second space 26 or vice versa.

The piston rod 16 enters the cylinder 12 through an inlet opening 28 at the second end, i.e., the end opposite the first end. Adjacent to the inlet opening 28 is a sealing device 30, through which the piston rod 16 is guided and by means of which the cylinder 12 is sealed off toward the outside. The sealing device 30 is mounted in the cylinder 12 between a notch 32 in the cylinder 12 and a flanged-over shoulder 34 so that it is unable to move.

The sealing device 30 has a magnetic element 36, which is installed inside a soft magnetic jacket 38. Between the soft magnetic jacket 38 and the piston rod 16, a first ferrofluid 40 is present, as a result of which a good seal is obtained between the piston rod 16 and the sealing device 30. A second ferrofluid 42 is present between the soft magnetic jacket 38 and the cylinder 12, as a result of which a reliable seal is achieved between the sealing device 30 and the cylinder 12. Because the ferrofluids 40, 42 are magnetizable fluids, the viscosity of which hardly changes in the magnetic field, the magnetic field of the magnetic element 36 is able to position the ferrofluids 40, 42 and to hold them in place in such a way that the escape of gas can be almost completely prevented, whereas at the same time the piston rod 16 is subject to only a small amount of fluid friction.

As FIG. 2 shows, an additional ferrofluid 44 can also be provided between the piston 14 and the cylinder 12. For this purpose, the piston 14 has a magnetic element 46, which is located in a soft magnetic jacket 48. By means of the additional ferrofluid 44, an especially effective seal is obtained between the first space 24 and the second space 26. The flow of gas between the first space 24 and the second space 26 is thus reliably prevented, but, as described in conjunction with FIG. 1, at least one bore (not shown) could be provided to make such flow possible.

The sealing device 30 can also have several magnetic elements 36, which are arranged next to each other in the axial direction and all of which are arranged inside a common soft magnetic jacket 38, as shown in FIG. 3. Especially when the magnetic elements 36 are oriented radially with respect to the arrangement of their magnetic north poles and their magnetic south poles, a sealing element 50 can be provided in the central area of each magnetic element 36. A homopolar orientation of the poles of all the magnetic elements 36 will generate an especially strong magnetic field between two adjacent magnetic elements 36, by means of which the ferrofluid 40 is held in place very effectively. The sealing elements 50, which merely have the function of preventing the ferrofluid 40 from escaping, are in this case arranged in a position where the magnetic field is the weakest. In particular, the magnetic field generated by the magnetic elements 36 is sufficient so that, even in the case that the force of gravity is acting in the direction of the arrow 52, the ferrofluid 40, 42, 44 will not flow away in the direction of the force of gravity.

FIG. 4 shows another embodiment of the invention, in which a ring-shaped magnetic element 54 is mounted outside the cylinder 12 near the inlet opening 28. The magnetic field generated by the magnetic element 54 intensifies the effect on the second ferrofluid 42 located between the sealing device 30 and the cylinder 12. The magnetic element 54, however, could also be designed to act alone, that is, without the magnetic element 36, at least on the second ferrofluid 42.

In the embodiment of the invention shown in FIG. 5, a ring-shaped magnetic element 58 is installed with freedom to move axially along the cylinder 12. If the piston-cylinder unit 10 is designed as, for example, a damper filled with a medium containing a ferrofluid, the ferrofluid 44 will collect between the piston 14 and the cylinder 12 when the axial movement of the piston rod 16 causes the piston 14 to arrive in the area of the magnetic element 58. This has the effect of blocking the piston 14, which means that the piston-cylinder unit 10 can be provided with a freely adjustable intermediate hold position.

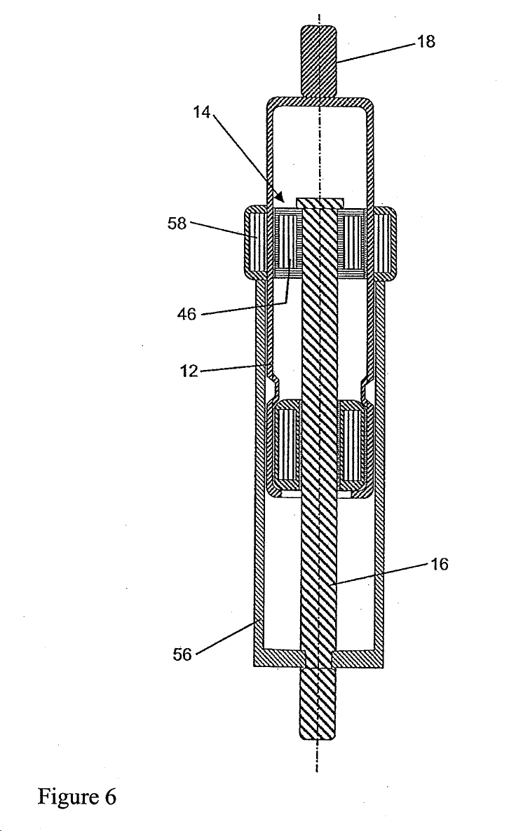

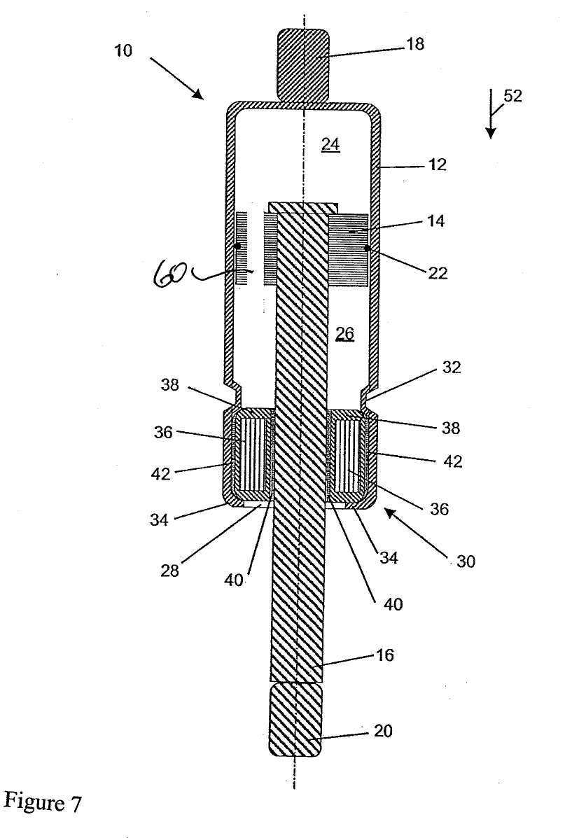

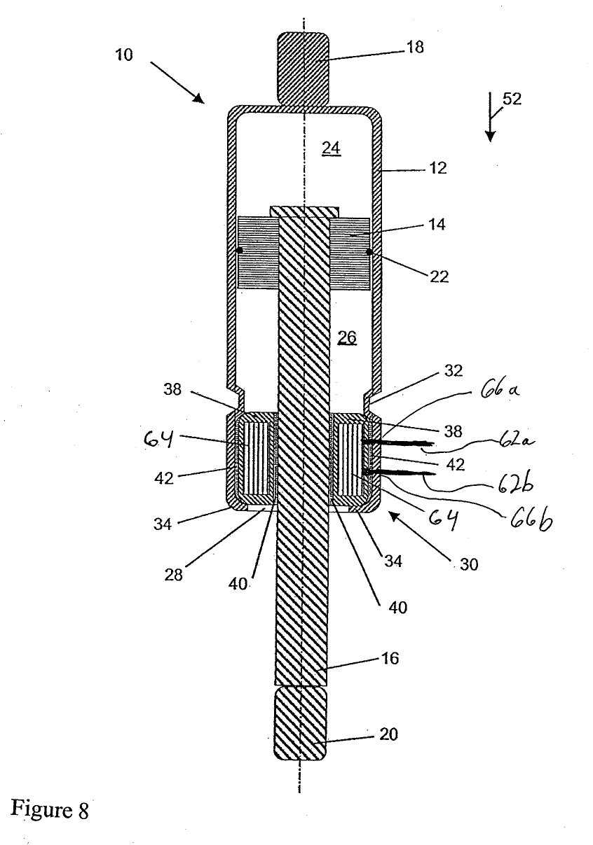

In the embodiment shown in FIG. 6, a jacket tube 56 is connected to the end of the piston rod 16 facing away from the piston 14 and extends at least partially over the cylinder 12. The magnetic element 58 is installed on the open end of the jacket tube 56 facing the first connecting device 18, where the piston 14 and the magnetic element 58 remain opposite each other at all times, one on the inside, the other on the outside of the cylinder 12. When the piston rod 16 moves axially out of the cylinder 12, for example, both the piston and the magnetic element 58 are moved into the same axial position. The magnetic field generated by the magnetic element 58 intensifies the effect on the third ferrofluid 44 located between the piston 14 and the cylinder 12. The magnetic element 58, however, could also be designed to act alone, that is, without the magnetic element 46, on the third ferrofluid 44.

### LIST OF REFERENCE NUMBERS

10 piston-cylinder unit
12 cylinder
14 piston
16 piston rod
18 connecting device
20 connecting device
22 O-ring
24 first space
26 second space
28 inlet opening
30 sealing device
32 notch
34 flanged-over shoulder
36 magnetic element
38 soft magnetic jacket
40 first ferrofluid
42 second ferrofluid
44 third ferrofluid
46 magnetic element
48 soft magnetic jacket
50 sealing element
52 arrow
54 magnetic element
56 jacket tube
58 magnetic element

1-14. (canceled)

15. A piston-cylinder unit, comprising:
a cylinder having a closed first end and a second end opposite the first end;
a piston installed in the cylinder with freedom to slide back and forth, the piston dividing the cylinder into a first space at the closed end and a second space at the end opposite the closed end;
a piston rod attached to one side of the piston, the piston rod projecting through the second space, and guided out of the cylinder concentrically with the longitudinal center axis of the cylinder at the second end;
a sealing device arranged at the second end, the piston rod extending through the sealing device;
a ferrofluid present cylinder; and
at least one magnetic element having a magnetic field which cooperates with the ferrofluid.

16. The piston-cylinder unit according to claim 15, wherein the sealing device comprises the magnetic element, and the ferrofluid is disposed at least one of between the sealing device and the piston rod and between the sealing device and the cylinder.

17. The piston-cylinder unit according to claim 15, wherein the piston comprises the magnetic element, and the ferrofluid is disposed between the piston and the cylinder.

18. The piston-cylinder unit according to claim 15, wherein the at least one magnetic element is mounted externally on the cylinder.

19. The piston-cylinder unit according to claim 15, further comprising a plurality of magnetic elements, wherein the magnetic poles of the magnetic elements are oriented radially with respect to each other.

20. The piston-cylinder unit according to claim 15, wherein a plurality of magnetic elements are arranged next to each other in at least one of the axial direction and the circumferential direction.

21. The piston-cylinder unit according to claim 15, further comprising a sealing element configured for limiting the axial flow of the ferrofluid, the sealing element disposed in an area axially centered on the magnetic element.

22. The piston-cylinder unit according to claim 15, wherein the magnetic element comprises a permanent magnet.

23. The piston-cylinder unit according to claim 15, wherein the magnetic element is formed by an electromagnet connected to power lines.

24. The piston-cylinder unit according to claim 15, wherein the sealing device comprises a soft magnetic jacket, wherein the soft magnetic jacket holds at least part of the magnetic element.

25. The piston-cylinder unit according to claim 15, wherein the piston comprises at least one opening configured for allowing gas to pass therethrough.

26. The piston-cylinder unit according to claim 15, further comprising a first connecting device and a second connecting device, wherein the cylinder is connected to a first component by the first connecting device, and the piston rod is connected to the second component by the second connecting device, and wherein the first connecting device is geodetically higher than the second connecting device.

27. The piston-cylinder unit according to claim 18, wherein the magnetic element is configured and arranged with freedom to move axially along the cylinder.

28. The piston-cylinder unit according to claim 27, further comprising a jacket tube having an open end, the jacket tube being connected to the end of the piston rod facing away from the piston and extending over at least part of the cylinder, wherein the magnetic element in disposed at the open end of the jacket tube facing the first connecting device.

29. The piston-cylinder unit according to claim 22, wherein the permanent magnet comprises SmCo or NdFeB.
